(19) United States
(12) Patent Application Publication
(10) Pub. No.: US 2009/0024450 A1
(43) Pub. Date: Jan. 22, 2009

(54) LOST SALES DETECTION AND ESTIMATION USING RETAIL STORE DATA

(75) Inventors: Li Chen, Cupertino, CA (US); Calvin Lee, San Francisco, CA (US); Baskar Jayaraman, Fremont, CA (US); Ihsan Kurt, San Jose, CA (US); Juliette Aurisset, Menlo Park, CA (US); Karthik Mani, San Jose, CA (US); Jie Weng, Sunnyvale, CA (US)

Correspondence Address: FISH & RICHARDSON P.C., PO BOX 1022, MINNEAPOLIS, MN, 55440-1022, US

(73) Assignee: TRUEDEMAND SOFTWARE, INC., Los Gatos, CA (US)

(21) Appl. No.: 12/176,286

(22) Filed: Jul. 18, 2008

Related U.S. Application Data
(60) Provisional application No. 60/950,589, filed on Jul. 18, 2007.

(51) Int. Cl. G06Q 10/00; G06Q 30/00

(52) U.S. Cl. 705/10

(57) ABSTRACT

Methods, systems, and apparatus, including computer program products, for detecting and estimating lost sales. A demand distribution for a product provided by a retail presence is determined. A probability of a lost sales occurrence is evaluated, including determining a predetermined time period and a probability of no sales over the predetermined time period. A determination of whether no sales have occurred over a time period corresponding in length to the predetermined time period is made. If the probability of no sales is below a threshold, an estimate of lost sales is determined.

### RELATED APPLICATIONS

This application claims the benefit under 35 U.S.C. §119 of U.S. Provisional Application No. 60/950,589, titled “LOST SALES DETECTION AND ESTIMATION USING RETAIL STORE DATA,” filed Jul. 18, 2007, which is incorporated by reference herein in its entirety.

### BACKGROUND

This specification is related generally to retail sales management.

Retailers experience lost sales when consumers do not find what they want on the store shelves. For example, the shelves may have run out of the product; this out-of-stock (OOS) condition can result in lost sales. As another example, the product is on the sales floor but sales are suppressed because the product is in the wrong location, hidden, or similarly inaccessible to the customer. Other causes of lost sales can include product damage, spoilage, and incorrect descriptions or prices.

Besides the impact on revenues, lost sales can impact store forecasts when they are not accounted for in the inventory replenishment system of the store. If lost sales are not accounted for, then a true picture of store demand will not be provided to the inventory replenishment system. The result will be under-forecasting and potential reduced order quantities, which can lead to even more lost sales.

Awareness of the lost sales also enhances store operations management. Lost sales can be used to identify and prioritize products or stores where replenishment or operational problems exist. Lost sales can also be used to track process improvement efforts.

Conventionally, lost sales are not directly observable and must be estimated from data that is available from a retail environment. Examples of such data sources are point-of-sale (POS) data and perpetual inventory (PI) data.

### SUMMARY

In general, one aspect of the subject matter described in this specification can be embodied in methods that include the actions of determining a demand distribution for a product provided by a retail presence, evaluating a probability of a lost sales occurrence, including determining a predetermined time period and a probability of no sales over the predetermined time period, determining if no sales have occurred over a time period corresponding in length to the predetermined time period; and if the probability of no sales is below a threshold, determining an estimate of lost sales. Other embodiments of this aspect include corresponding systems, apparatus, computer program products, and computer readable media.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an example system for detecting and estimating lost sales.

FIG. 2 illustrates an example lost sales estimation scenario.

FIG. 3 illustrates another example lost sales estimation scenario.

Like reference numbers and designations in the various drawings indicate like elements.

### DETAILED DESCRIPTION

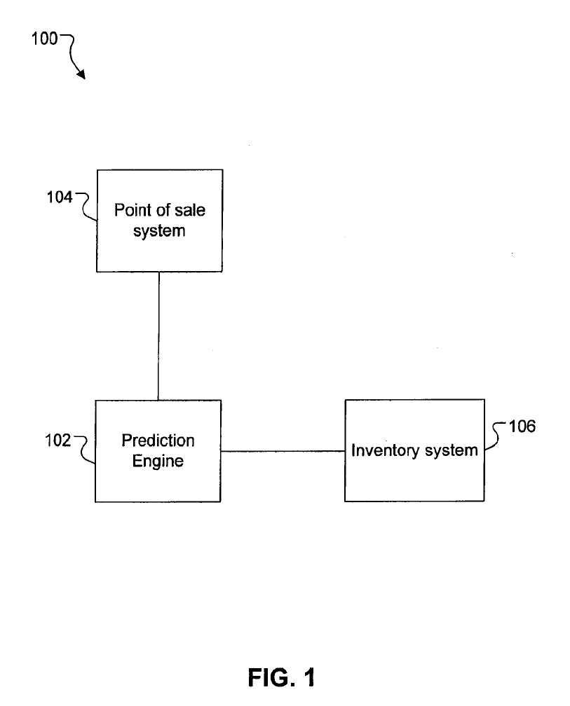

FIG. 1 is a block diagram illustrating an example system 100 for detecting and estimating lost sales. The system 100 includes a prediction engine 102 that operates to detect and estimate lost sales. Input to the prediction engine 102 can come from a variety of other systems, including a point of sale system 104 (providing point of sale data to the prediction engine 102). The prediction engine 102 can also exchange data with other system, such as an inventory system 106, for example.

Detection and estimation of lost sales can be done for two scenarios related to inventory at the end of an analysis cycle. Lost sales can be estimated for a scenario where the end-of-day store inventory is zero and a scenario where the end-of-day inventory is positive (greater than zero).

Lost Sales Detection and Estimation with Zero Store Inventory

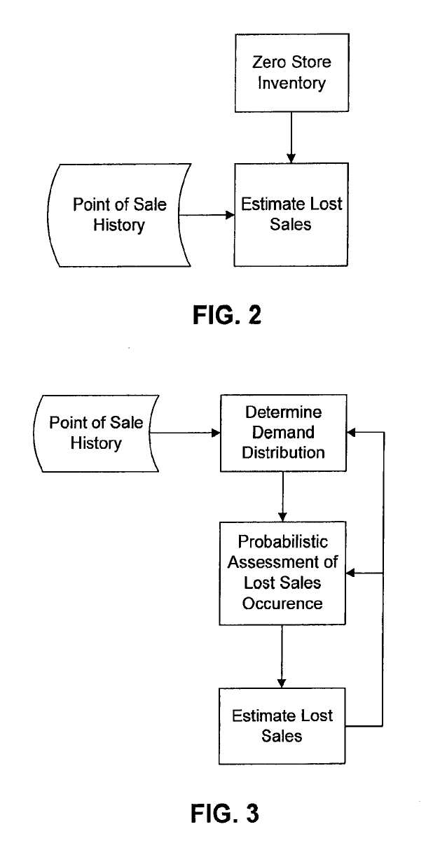

FIG. 2 illustrates an example lost sales estimation scenario. When the store inventory at the end of a day is zero, the implication is that the store ran out of inventory on that particular day. As a result, lost sales may have occurred on that day. In this case, the lost sales detection becomes a matter of checking whether or not the end-of-day store inventory is zero.

Suppose that the observed sales on day t are Sₜ, where the end-of-day store inventory on that day is zero. Assume that the demand probability mass function (which can be any suitable probability mass function for estimating or approximating demand) is given by p(x), with x≧0. In this scenario, system 100 (e.g., the prediction engine 102) can estimate the lost sales on day t using the formula:

LostSales=Σ_{x ≧S}_{ₜ}(x−Sₜ)p(x).

Lost Sales Detection and Estimation with Positive Store Inventory

When the end-of-day store inventory is positive, system 100 can use one or more algorithms that utilize existing retail POS data to detect lost sales as they occur and to estimate the value of the lost sales.

From the daily POS data for a specific product-location combination (for example, and hereinafter referred as (for convenience), a Stock Keeping Unit or SKU), the daily net sales for a day can be observed by the system 100. Lost sales can be detected when the net sales are depressed for extended periods of time. In some implementations, when sales are zero for consecutive periods or for a predetermined amount of time (e.g., days), there is a probability of lost sales occurring. The system 100 can be configured to find these time periods (e.g., days) when the probability that a SKU has incurred lost sales is relatively high.

In some implementations, system 100 (e.g., the prediction engine 102) can: (1) determine the underlying distribution of demand for a SKU; (2) calculate a probability of the SKU having no sales for a given time period (e.g., a number of consecutive days); and (3) if lost sales are deemed likely (e.g., the calculated probability of the SKU having no sales for the given time period is above a threshold), calculate the estimated lost sales. An illustration of a flow associated with this scenario is shown in FIG. 3.

### Step 1: Determining the Demand Distribution

The demand distribution for a SKU can be determined by, for example, fitting a parametric distribution with observed POS sample data.

A way to determine the mean and variance of the underlying demand distribution is to use the forecasted sales fₜ as the mean and the forecast error variance vₜ. Note that these values account for the day-of-the-week as well as any seasonal effects on day t.

Another way to determine the mean and variance of the demand distribution is to directly calculate the mean and variance from sample data. In some implementations, before the prediction engine 102 calculates the mean and variance, system 100 optionally cleanses the POS data. For example, let y₁, y₂, . . . , y_{N} be the historical daily POS observations, with N being the number of samples. Starting with these historical values, one or more clear outliers are removed from the de-trended series. For example, the following procedure can be used:
1. Calculate the following:

$${c}_{1} = {\sum }_{i = 1}^{N} {y}_{i} , {c}_{2} = {\sum }_{i = 1}^{N} {iy}_{i} , {c}_{3} = {\sum }_{i = 1}^{N} {y}_{i}^{2} , \\ b = \frac{12 {c}_{2} - 6 ( N + 1 ) {c}_{1}}{N ( N - 1 ) ( N + 1 )} , a = \frac{2 {c}_{1} - bN ( N + 1 )}{2 N} , \\ s = \sqrt{\frac{{c}_{3} - a {c}_{1} - {bc}_{2}}{N - 2}} .$$

2. For every yᵢ, i=1, 2, . . . , N, compute ŷᵢ=a+bi.
3. If yᵢ>ŷᵢ+4s, replace yᵢ with ŷᵢ+4s. If yᵢ<ŷᵢ−4s, replace yᵢ with ŷᵢ−4s.
4. If no observations were replaced in Step 3, exit this procedure. If this step has been reached more than three times, exit this procedure. Otherwise, return to Step 1.

The yᵢ values from the procedure described above will be hereinafter referred as “cleansed POS values” for convenience, and will be denoted using the same yᵢ notation in the description below.

Using the cleansed POS values, the prediction engine 102 can calculate the mean M₁ and variance M₂ (and k-th order centered-moments Mₖ) of the underlying distribution as follows:

$${M}_{1} = \frac{1}{N} {\sum }_{i = 1}^{N} {y}_{i} , \\ {M}_{2} = \frac{1}{N - 1} {\sum }_{i = 1}^{N} {( {y}_{i} - {M}_{1} )}^{2} , \\ {M}_{k} = \frac{1}{N - 1} {\sum }_{i = 1}^{N} {( {y}_{i} - {M}_{1} )}^{k} ,$$

where y₁, y₂, . . . , y_{N} are the cleansed POS values from the procedure above.

With the sample mean, variance, and potentially the k-th order centered-moments, the prediction engine 102 can then determine an appropriate probability distribution P (e.g., Poisson, geometric, etc.) that fits these sample statistics.

### Step 2: Accessing the Probability of a Lost Sales Occurrence

From the demand distribution determined in Step 1, the prediction engine can calculate the probability Pᵢ of zero sales (e.g., on a given day). Assuming no correlation of demand across days, the probability of zero sales for the k days t, t+1, . . . , t+k−1 is

$${P}_{t , t + k - 1} = {\prod }_{i = t}^{t + k - 1} {P}_{i} ,$$

where Pᵢ is determined using the probability distribution P from Step 1.

Let ε be the minimum pre-specified acceptable probability level in order to not reject the conclusion that the days t, t+1, . . . , t+k−1 with zero sales had suffered lost sales. With this definition for ε, if P_{t, t+k-1}<ε, prediction engine 102 can predict that lost sales had occurred over the k days t, t+1, . . . , t+k−1.

If the correlation of demand between days is not zero, the prediction engine 102 can adjust the threshold ε lower (e.g., by a predetermined amount) to account for the correlation r. For example, if the correlation coefficient is r, then the prediction engine 102 can replace ε with ε(1−r²).

### Step 3: Estimate Lost Sales

If the above Step 2 leads to a conclusion that lost sales have occurred on day t, the lost sales can be estimated by the prediction engine 102 as, for example, the mean demand for that day. For example, the mean demand can be estimated as the demand forecast fₜ or the sample mean M₁.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
determining a demand distribution for a product provided by a retail presence;
evaluating a probability of a lost sales occurrence, including determining a predetermined time period and a probability of no sales over the predetermined time period;
determining if no sales have occurred over a time period corresponding in length to the predetermined time period; and
if the probability of no sales is below a threshold, determining an estimate of lost sales.

2. The method of claim 1, wherein determining a demand distribution comprises fitting a parametric distribution with observed point of sale (POS) sample data.

3. The method of claim 1, wherein evaluating a probability of a lost sales occurrence comprises adjusting a threshold if a correlation of demand over an interval in the predetermined time period is not zero.

4. The method of claim 1, wherein the time period is a period of a plurality of days.

5. The method of claim 1, wherein estimating lost sales comprises estimating the lost sales using a mean demand associated with the time period.

6. An apparatus comprising:
a prediction engine operable to
determine a demand distribution for a product provided by a retail presence;
evaluate a probability of a lost sales occurrence including determining a predetermined time period and a probability of no sales over the predetermined time period;
determine if no sales have occurred over a time period corresponding in length to the predetermined time period; and
if the probability of no sales is below a threshold, determine an estimate of lost sales.
